(19) United States
(12) Patent Application Publication
(10) Pub. No.: US 2003/0175403 A1
(43) Pub. Date: Sep. 18, 2003

(54) Potentiated bioactive additives and method of use

(76) Inventor: Michael H. Gurin, Glenview, IL (US)

Correspondence Address: Michael Gurin, 4132 Cove Lane, Unit A, Glenview, IL, 60025, US

(21) Appl. No.: 10/386,718

(22) Filed: Mar. 13, 2003

Related U.S. Application Data
(60) Provisional application No. 60/363,864, filed on Mar. 14, 2002.

(51) Int. Cl. A23D 7/00

(52) U.S. Cl. 426/607

(57) ABSTRACT

A composition and method for supplementing feed, nutrition and diet systems with bioactive additives comprised of a synergistic blend of conjugated diene acids in either a glyceride form, or alkali and alkaline salts; chia and lesquerella seeds with their respective derivative products; and food enhancing additives. The composition further comprises a synergistic blend of food enhancing enzymes, microalgae, and immunopotentiators as a means to further increase nutritional value. The composition further provides an effective increase in therapeutic, and pharmacological properties in nutrition and diet systems.

### CROSS-REFERENCE TO RELATED APPLICATIONS

This application is a continuation in part of U.S. Provisional Patent Application Serial No. 60/363,864 titled “Bioactive Conjugated Acids and Method of Use”, recently filed on the Mar. 14, 2002 which is hereby incorporated by reference without priority claim.

### BACKGROUND OF THE INVENTION

The present invention relates to the field of human and animal nutrition, and in particular to nutritional compositions containing bioactive conjugated acids (BA-CA) with uniquely synergistic additional bioactive components to further enhance the food value of said compositions. The present invention also relates to nutritional compositions containing omega-3 and omega-6 essential fatty acids, and omega-9 with the additional bioactive components to further enhance the food value of said compositions.

The family of omega-3, -6, and -9 oils is a critical collection of oil components known as polyunsaturated fatty acids, also known as “PUFAs”. Omega-6 oils include linoleic acid, gama-linolenic acid, dihomo-gama-linolenic acid, and arachidonic acid. Omega-3 oils include alfa-linolenic acid (C18:3), eicosanpentaen acid (C20:5) “EPA”, and docosahexaen acid (C22:6) “DHA”. The eicosapentaen acid “EPA” and docosahexaen acid “DHA” are essential fatty acids. Omega 9 fatty acid, or Oleic acid, may sometimes be mistaken as an EFA, but it is not because humans can produce a limited amount. Oleic Acid is the primary Mono-unsaturated fatty acid (MUFA) found in olive oil, and rice bran oil to name a few raw material feed sources.

Omega-3 PUFAs help to prevent cardiovascular diseases, hypertonia, and Diabetes mellitus. They also act against inflammation, allergic diseases like psoriasis, neurophysiological functions and brain and vision development of newborn infants. The role of omega-3 fatty acids in the prevention of depressions is also being studied. Oleic acid is associated with reduces atherosclerosis (hardening of the arteries), reduced insulin resistance and, thus, improved glucose (blood sugar) maintenance, improved immune system function, and for possible protective effects from some cancers. Numerous studies point to a modest beneficial effect of olive oil consumption on breast cancer risk.

The family of conjugated diene acids is gaining recognition as potent antioxidants with a wide range of health and nutritional benefits. A conjugated diene acids are by definition an organic molecule having two carbon-carbon double bonds positioned next to one another.

Chia (Slavia hispanica L.) seed has been shown to hold significant potential in the food industry. Chia possess the highest percentage of the polyunsaturated fatty acids, α-linolenic and linoleic (i.e. 83.2%), of all crops. This is followed by safflower and sunflower, with 75% and 67% respectively. This difference is even more significant if one considers that safflower and sunflower lack α-linolenic acid. Rapeseed oil also offers a high degree of unsaturation (67%), but this arises because of a high oleic (monounsaturated) acid content, giving it a relatively low content (27%) of polyunsaturated fatty acids. Chia seed possesses 19-23% protein. This percentage compares favorably with other nutritional grains such as wheat (14%), corn (14%), rice (8.5%), oats (15.3%), barley (9.2%), and amaranth (14.8%). Chia seed also is a good source of B vitamins, calcium, phosphorus, potasium, zinc, copper, essential oils of significance in the flavors and fragrance industries including β-caryophyllene (13.3-35.7%), globulol (12.8-23.4%), γ-muurolene (4.4-17.6%), β-pinene (2.5-15.1%), α-humulene (3-6.1%), germacrene-B (1.8-5%), widdrol (1.3-2.4%), β-Bourbonene, linalool, valencene, and τ-cadinol.

Lesquerella seed contains an oil rich in hydroxy fatty acids (HFA), an important raw material used by industry for making resins, waxes, nylons, plastics, corrosion inhibitors, coatings, lubricating greases, and cosmetics. The oil from most species of Lesquerella found in the western U.S. contains lesquerolic acid as the predominate HFA. The molecular structure of this HFA is similar to ricinoleic acid of castor oil, except that Lesquerella has two additional carbons at the carboxyl end of the carbon chain. Essentially all castor oil production in the U.S. has been eliminated by a combination of economic factors, excessive allergenic reactions of field and processing workers, and toxicity of the seed meal. Lesquerella could serve as a partial replacement for imported castor oil, along with other formulation possibilities provided by the longer chain length of the hydroxy fatty acids. The dehydration of the lesquerolic component from lesquerella seed oil results in conjugated diene acid. Dehydration reaction, also known as condensation reaction, is a reaction joining two compounds with resultant formation of water; commonly exhibited in synthesis reactions involving organic molecules.

Conjugated linoleic acid (CLA), generally understood as a family of positional and geometric isomers of linoleic acid (cis-9, cis-12-octadecadienoic acid), has been and is the focus of numerous research programs that seek to capitalize on its nutritional, therapeutic, and pharmacological properties. CLA has been incorporated into the diet in liquid, gel or powdered forms, though the preferred method of administration is generally oral. The CLA has also been formulated with suitable carriers such as starch, sucrose or lactose in tablets, capsules, solutions and emulsions. CLA preparations are also provided as supplements in various prepared food products. A wide range of existing applications where CLA is directly incorporated into prepared food products includes diet products (diet drinks, diet bars and prepared frozen meals) and non-diet products (candy, snack products such as chips, prepared meat products, milk, cheese, yogurt and any other fat or oil containing foods).

CLA is a product with conclusive health and nutritional benefits. One mechanism whereby CLA reduces body fat is by enhancing insulin sensitivity so that fatty acids and glucose can pass through muscle cell membranes and away from fat tissue. CLA may help block fat cells that are in the body from filling up with fat. CLA also may have some effect on skeletal muscle, possibly stimulating muscle growth and fat burning. CLA inhibits the body's mechanism for storing fat and causes the body to utilize fatty reserves for energy. CLA also increases hormone sensitive lipase activity. This is an enzyme that breaks down fats stored in fat cells on the body. The fatty acids are returned to the blood stream to be used by muscle cells as an energy source. CLA has been shown to inhibit lipoprotein lipase. This is an enzyme that breaks down fat globules in the blood so that adipocyte (fat cell) uptake (body fat accumulation) can occur. The inhibition of lipoprotein lipase results in reduced fat deposition. CLA also has powerful antioxidant properties. It has been proposed that adding CLA to foods may prevent mold growth and oxidation. Thus, it is likely that the basis for the effect of CLA is an inhibition of lipid filling or an increase in lipid mobilization.

Another alternative method to achieve comparable benefits in feed efficiency of animals, dietary supplements for optimal weight gain and lean tissue of animals, nutritional benefits in human consumption as dietary supplements is L-carnitine. Work has been performed with Carnitine to achieve certain of these results and varying degrees of success have been achieved. Carnitine is chemically termed 3-hydrosy-4-N-trimethylamine butyric acid, and is similar to choline and a close cousin to amino acids. Unlike amino acids, Carnitine is not used for protein synthesis. Only the L-isomer of Camitine is biologically active. Carnitine is essential in the metabolism and movement of fatty acids within and between cells. To meet daily energy requirements, the body primarily utilizes fatty acids and carbohydrates. In order for fatty acids to be used for energy, they must first be transported from outside a cell (the cytosol side) to inside a cell (the mitochondria). Carnitine is the vehicle that transports these fats. Once transported inside the mitochondria, these fatty acids are broken down through a process called beta-oxidation.

The prior art establishes two distinct and separate methods to increase feed efficiency, weight gain, and lean tissue of animals. The first is the use of CLA and the second is L-carnitine. Each of these methods achieves their respective results from distinct mechanisms. L-carnitine acts as a shuttle molecule, transporting fatty acids into the mitochondria. One mechanism whereby CLA reduces body fat is by enhancing insulin sensitivity so that fatty acids and glucose can pass through muscle cell membranes and away from fat tissue.

The notion of a L-carnitine as a synergistic supplement with conjugated linoleic acid for the enhanced effectiveness of CLA and L-carnitine is absent from the prior art. None of the prior references utilize the superior composition of L-carnitine and CLA.

The notion of a L-carnitine as a synergistic supplement with conjugated diene acids from dehydration of lesquerolic oil for the enhanced effectiveness of CA and L-carnitine is absent from the prior art. None of the prior references utilize the superior composition of L-carnitine and CA.

The patent literature is void of the utilization of bioactive free fatty acids of conjugated diene acids and further conversion into alkali or alkaline salts of dehydration compounds, hereinafter referred to as potentiated bioactive additive “PBA” as a feed and food additive. Research literature is also absent of the presence of potentiated bioactive additives derived in part from chia and/or lesquerella seeds, and/or their derivative products such as oils, carbohydrates, antioxidants, and proteins, in animal or human diets. The notion of utilizing PBA directly as a feed and food additive is also absent from the patent and research literature. The notion of further subsequent encapsulation of PBA and/or salts of PBA is also absent from the patent and research literature. The further notion of subsequent interesterification through enzymes is also absent from the patent and research literature.

The present invention provides a new, optimal and low cost diet composition and method of use, which achieves superior performance over the above-referenced prior art, and others.

### SUMMARY OF THE INVENTION

As used herein, the term “bioactive composition” include at least one from the group of conjugated diene acids, alkali and alkaline salts of conjugated diene free fatty acids, chia seed, chia oil, chia protein, lesquerella seed, lesquerella oil, and lesquerella protein.

As used herein, the term “food enhancing enzyme” are enzymes that by improving feed digestibility are able to increase the efficiency of the feed utilization. Feed enhancing enzymes function by enhancing the digestibility of feed components. This enhancement may e.g. be brought about by degradation of polysaccharides. In e.g. chia and lesquerella seeds, galactans constitute a significant part of the pectinous non-starch polysaccharides. In monogastric animals the non-starch polysaccharides are not degraded in the small intestine by the digestive enzymes, and hence do not offer their full energy potential to the animal.

The term “animal” includes all animals, including human beings. Examples of animals are mono-gastric animals, e.g. pigs (including, but not limited to, piglets, growing pigs, and sows); poultry such as turkeys and chicken (including but not limited to broiler chicks, layers); young calves; and fish (including but not limited to salmon); and multi-gastric animals, e.g., cattle.

The term “feed” or “feed composition” means any compound, preparation, mixture, or composition suitable for, or intended for intake by an animal. In a particular embodiment, one or more seed sources including chia and lesquerella are included in the feed.

The term “improving the nutritional value of an animal feed” means improving the solubilisation and/or degradation of the galactans, mono- and poly-unsaturated fatty acids, essential fatty acids, thereby leading to increased availability of nutrients. In a particular embodiment, “improving the nutritional value of an animal feed” further means improving the immune system of animal consuming said animal feed. The nutritional value of the feed is therefore increased, the health value of the feed is therefore increased, and the growth rate and/or feed conversion ratio (i.e. the weight of ingested feed relative to weight gain) of the animal is improved.

The term “organoleptic” means mouthfeel, smell, and taste qualities.

The term “nutritional” means positive contribution of nutrients, energy, proteins, and health promoting qualities.

The term “shelf-life” means length of time prior to any significantly detrimental deterioration of nutritional, and organoleptic qualities.

The term “enzymatic interesterification” means utilizes enzymes to esterify products free of trans fatty acids and with special physical and chemical characteristics.

The term “improve the isolation” means extracting a higher amount of the desired component at a higher purity level.

The term “enrich” means to add higher levels of the desired component beyond the natural levels of the bioactive composition.

The term “resulting animal products” means animal products derived from animals having consumed said animal feeds comprised of bioactive compositions.

As used herein, the term “taste of oxidized oil” means the accompanying taste of rancid and oxidized oil, often described as fishy smelling when the oil is sufficiently oxidized to be detected by animals.

The term “human food” includes but is not limited to animal products, grains, meat, poultry, egg, fish, spreads, nut products, beverages, confectionery products, oral care products, and dressings.

As used herein, the term “confectionery products” include cookies, bars, fudge, caramels, taffy, mints, chocolates, butters, spreads, chewing gum, and gummy products.

As used herein, the term “beverage products” include dry powder mixes, carbonated drinks, dairy milk and yogurt drinks, non-dairy milk and yogurt drinks, chocolate drinks, coffees, and teas.

As used herein, the term “oral care products” includes chewing gums, mints, toothpaste, mouthwash, breathstrips, edible films, liquid concentrate drops, and soft capsules.

As used herein, the term “potentiated” refers to additives that potentiate nutritional and health value beyond the level of non-potentiated additives.

The term “immunopotentiator” used in this specification means “potentiation of the immune function of an animal such as a human being, a mammal, fish or the like”.

The inventive bioactive composition achieves enhanced nutritional value by including a conjugated diene acid preferably from the group of conjugated diene acids in a glyceride form, more specifically glycerides comprising monoglyceride, diglyceride and triglyceride isomers and esters.

The inventive bioactive composition achieves enhanced nutritional value by including a conjugated diene acid preferably from the group of conjugated diene acids in alkali or alkaline salt form of conjugated diene free fatty acids.

In accordance with another aspect of the invention, the conjugated diene acid is further compounded with another bioactive additive from the group of food enhancing enzyme, microalgae, and immunopotentiator.

In accordance with another aspect of the invention, the conjugated diene acid is selected from at least one from the group consisting of glycerides comprising monoglyceride, diglyceride and triglyceride isomers and esters. A specifically preferred conjugated diene acide is a glyceride of conjugated linoleic acid. A more specifically preferred conjugated linoleic acid is produced by the steps of dehydrating castor oil yielding dehydration compounds, alkaline saponification of dehydrated compounds yielding conjugated linoleic acid free fatty acid compounds, and separating bioactive conjugated linoleic acid from the alkaline saponification compounds. A particularly preferred conjugated linoleic acid is comprised of at least one isomer selected from the 9/11 and 10/12 isomers.

In accordance with yet another aspect of the present invention, the conjugated diene acid is either an alkali and alkaline salts of conjugated diene free fatty acids. A more specifically preferred conjugated linoleic acid is produced by the steps of dehydrating castor oil yielding dehydration compounds, alkaline saponification of dehydrated compounds yielding conjugated linoleic acid free fatty acid compounds, and separating bioactive conjugated linoleic acid from the alkaline saponification compounds. A particularly preferred conjugated linoleic acid is comprised of at least one isomer selected from the 9/11 and 10/12 isomers.

In accordance with another aspect of the present the conjugated diene acid is produced by the dehydration reaction of oil derived from at least one of the group of chia and lesquerella seeds. A more preferred conjugated diene acid is further subjected to alkaline saponification of dehydrated compounds yielding conjugated diene acid free fatty acid compounds. And a particularly preferred conjugated diene acid is isolated from the alkaline saponification compounds.

In yet another aspect of the present invention the conjugated diene acid is further comprised of L-carnitine. A more preferred L-carnitine is selected from the group consisting of free L-carnitine, L-carnitine L-tartrate, L-carnitine magnesium citrate and acetyl-L-carnitine.

Yet another aspect of the present invention is further comprised of at least one oil from the group of oils including rice bran oil, and oils containing omega-3 and omega-9 polyunsaturated fatty acids, and eicosapentaenoic acid and docosahexaenoic acid.

Another aspect of the present invention is the bioactive composition subjected to at least one process selected from the group of emulsifying into a microemulsion, encapsulating into a microencapsulation, and esterifying through enzymatic interesterification.

Encapsulation is a powerful means to enhance the performance of the bioactive composition in accordance of the present invention. The encapsulant shell according to the present invention is preferably comprised of at least one from the group of gum arabic, fat mimetics, liposomes, liposomes in sol-gels, shellac, fats, hydrolyzed fats, ethyl cellulose, hydroxy propyl methylcellulose, starches and modified starches, polymers, waxes, alginate & alginic acid (e.g., sodium alginate), calcium caseinate, calcium polypectate, carboxyl cellulose, carrageenan, cellulose acetate phthalate, cellulose acetate trimellitate, chitosan, corn syrup solids, dextrins, fatty acids, fatty alcohols, gelatin, gellan gums, hydroxy cellulose, hydroxyl ethyl cellulose, hydroxy methyl cellulose, hydroxy propyl cellulose, hydroxy propyl ethyl cellulose, hydroxy propyl methyl cellulose, hydroxy propyl methyl cellulose phthalate, lipids, liposomes, low density polyethylene, mono-, di- and tri-glycerides, pectins, phospholipids, polyethylene glycol, polylactic polymers, polylactic co-glycolic polymers, polyvinyl pyrolindone, stearic acid and derivatives, gums (e.g., xanthum) and proteins (e.g., zein, gluten).

Numerous means of creating encapsulations are known in the industry, whereby the bioactive composition is encapsulated, and incorporated in the present invention including subjecting encapsulated ingredients to means selected from the group of dropping method filler, spray dried, fluid-bed coated, coacervation, molten encapsulating with spray chilling, and mixing flavor enhancer with a polymer as the encapsulating agent with the resulting mixture being extruded into fine fibers, mixed with an absorbent, and included in a powder material.

In accordance with the present invention, encapsulated ingredients are further comprised of at least one from the group of glycerides selected from enzymatically modified oils, fats, and fatty acids of mono-, di-, and tri-glycerides; glycerides selected from lipolyzed modified oils, fats, and fatty acids of mono-, di-, and tri-glycerides; pervaporated flavors; high intensity sweeteners; ingredients selected from the group of colorants, nutraceutical actives, pharmaceutical actives and antioxidants; salt or salt substitutes; prior encapsulated actives; and standard flavors. The utilization of multiply encapsulated bioactive composition is in accordance and preferred in the present invention. The multiply encapsulated shell is further comprised of alternating shells made from water or oil soluble ingredients that further encapsulate at a minimum the prior encapsulated actives.

The more specifically preferred encapsulation is further comprised of active release agents to achieve controlled release of bioactive composition, flavor, pharmaceutical, or nutraceutical actives; bioadhesive agents to bind encapsulant shell and encapsulated actives to mucin and mucosa; and time release agents to regulate the dissolution, melting, or diffusion of the shell. The encapsulated shell is designed to achieve release of the encapsulated bioactive composition by at least one mechanism selected from the group of mechanical rupture of the capsule shell, dissolution of the shell, melting of the shell, and diffusion of the shell.

In accordance with another aspect of the invention, animal feed, and human food products are further comprised of oils and fats in the triglyceride form processed by enzymatic interesterification to obtain products free of trans fatty acids and with special physical and chemical characteristics. Enzymatic interesterification process can create a random distribution, or it may be directed to a degree that actually modifies the shortening properties, without increasing saturation or creating trans isomers.

In accordance with yet another aspect of the present invention, the oils and fats being enzymatic interesterified are preferably selected oils and fats in the triglyceride form having a minimum of 10% on a weight basis of one or more of omega-3 and omega-9 polyunsaturated fatty acids, eicosapentaenoic acid “EPA” and docosahexaenoic acid “DHA”.

The inventive bioactive composition is comprised of at least one from the group of chia seed, chia oil, chia protein, lesquerella seed, lesquerella oil, lesquerella protein, and at least one additional bioactive component selected from the group of food enhancing enzyme, microalgae, and immunopotentiator. A more preferred food enhancing enzyme is selected from the group consisting of galactanases, xylanases, proteases, carbohydrases, lipases, reductases, oxidases, transglutaminases, and phytases; and mixtures thereof. A more specifically preferred enzyme is selected from the group of enzymes consisting of galactanases.

Another aspect of the present invention is the modification of oil derived from at least one from the group of chia and lesquerella seeds to modify organoleptic qualities. A more preferred modification of oil is subjected to a process selected from the group of emulsifying into a microemulsion, encapsulating into a microencapsulation, and esterifying through enzymatic interesterification. A more particularly preferred composition is further comprised of oils derived from rice bran, dehydrated castor, dehydrated chia, dehydrated lesquerolic, and conjugated linoleic acids as a means to enrich omega-3 and antioxidant levels. Another preferred composition is further comprised of oils containing at least one of omega-3, omega6, and omega-9 polyunsaturated fatty acids, and eicosapentaenoic acid and docosahexaenoic acid. A more preferred oil contains a minimum of 10% on a weight basis of one or more of omega-3, and omega-9 polyunsaturated fatty acids, and eicosapentaenoic acid and docosahexaenoic acid.

Yet another aspect of the present invention is the subsequent inclusion of said bioactive compositions into an animal feed, human food, animal products resulting from consumption of said animal feeds, or dietary supplements.

In accordance with another aspect of the present invention said bioactive compositions are compounded into animal feed comprised of dry or wet mixtures of nutrients, proteins, carbohydrates, and fats.

In accordance with yet another aspect of the present invention said bioactive compositions are compounded into human food comprised of dry or wet mixtures of nutrients, proteins, carbohydrates, and fats.

Yet another aspect of the present invention is the subsequent inclusion of said bioactive compositions with standard dietary supplements. A more preferred bioactive composition is manufactured into least one of the forms selected from the group of capsules, liquid drops, or dry powders.

The inventive bioactive composition improves the isolation of oil, protein, carbohydrate, and fiber from within either of the chia or lesquerella seeds through the utilization and inclusion of a galactanase enzyme.

An advantage of conjugated diene acid in the form of glycerides or salts is the reduction or elimination of burning taste associated with free fatty acids.

An advantage of the present invention is an increase of nutritional value of said animal feed, human food, and animal products resulting from consumption of said animal feeds whereby nutritional value include, but are not limited to, increased omega-3 content, antioxidant, solubility and digestion of soluble and insoluble fibers, availability of protein and oils, and reduced levels of oxidized oils.

Yet another advantage of the present invention is an improvement of organoleptic properties of said animal feed, human food, and animal products resulting from consumption of said animal feeds whereby organoleptic properties include, but are not limited to, mouthfeel, texture, viscosity, and melt temperature.

Another advantage of the present invention is a lengthening of shelf-life stability of said animal feed, human food, animal products resulting from consumption of said animal feeds, and dietary supplements due in part, though not limited to, high antioxidant levels within said bioactive composition and higher antioxidant potential of conjugated diene acid over non-conjugated acid.

An advantage of the present invention is a superior taste of said animal feed, human food, animal products resulting from consumption of said animal feeds, and dietary supplements due in part, though not limited to, reduced oxidation levels thus avoiding a fishy taste typically resulting from the oxidation of oils, particularly oils rich in omega-3 content.

Another advantage of the present invention is a controlled bioactive composition release over an extended duration.

Yet another advantage of the PBA-L-carnitine Blend is that the performance of the blend is superior to the performance of the individual components by acting synergistically amongst the bioactive components. Another advantage of the PBA-L-carnitine Blend when utilized in animal feeds is the increased efficiency of feed conversion into lean body weight. A yet further advantage of the PBA-L-carnitine Blend is the increase in fat firmness and improvement of meat quality in animals.

Additional features and advantages of the present invention are described in and will be apparent from the detailed description of the presently preferred embodiments. It should be understood that various changes and modifications to the presently preferred embodiments described herein will be apparent to those skilled in the art. Such changes and modifications can be made without departing from the spirit and scope of the present invention and without diminishing its attendant advantages. It is therefore intended that such changes and modifications be covered by the appended claims.

### DETAILED DESCRIPTION OF THE PREFERRED EMBODIMENTS

A bioactive composition comprised of a conjugated diene acid, hereinafter referred to as “CDA” in the form of either a glyceride or salt, as a means to reduce or eliminate the burning taste associated with conjugated diene acids in the free fatty acid form, enhances the nutritional value of animal feeds. One such CDA is conjugated linoleic acid, hereinafter referred to as “CLA”.

The preferred CLA component is influenced by a number of factors, including cost effectiveness, fat content in diet, dispersion and settling characteristics, addition of glycerin and emulsion characteristics. More preferred bioactive isomers of CLA include the bioactive isomers of cis-9, trans-11 and trans-10, cis-12.

The scientific literature suggests that the active CLA isomers are c9, t11 and t10, c12 isomers with conflicting evidence within the application of animal feed supplement. CLA derived from dehydrated castor oil, hereinafter referred to as “DCO” in the alkali salt, alkaline salt, and encapsulated forms eliminate the negative feed intake characteristics associated with the CLA in the free fatty acid form, thus greatly reducing the otherwise known requirement of specific ratio between the two bioactive isomers. Therefore, it is an object of the present invention to provide CLA compositions containing CLA isomers exclusively in the salt and encapsulated forms. It is also an object of the present invention to provide methods for using CLA compositions containing CLA in biologically favorable ratios, and of biologically active isomers in enriched content for optimization of the desired biological effects.

CLA as derived from the dehydration process, also known as condensation reaction, of castor oil provides a CLA delivery system that meets the requirement of an isomeric mixture of conjugated linoleic acid but not pure cis-9, trans-11-octadecadienoic acid to act synergistically with the other CLA isomers present to exert its biological effects. Structured lipids can also be formed, by combining glycerol and fatty acids into a triglyceride, using esterification. Triglycerides are lipids that are made by esterification of glycerine (a triol) with fatty acids. The products comprise an equilibrium mixture of the monoglycerides, diglycerides and triglycerides in the esterification reaction of fatty acids with glycerin.

Conjugated dienes are also derived from the dehydration process of oils from chia and lesquerella seeds. Chia and lesquerella seeds have the unique advantage over other conjugated dienes due to the relatively high concentration of natural antioxidants. This increases the total antioxidant levels of the bioactive composition beyond the attributed levels of conjugated dienes inclusive of conjugated linoleic acid. The dehydration process on lesquerella oil can result in a higher concentration of conjugated dienes by the subsequent alkaline saponification of said resulting compounds. The resulting product can then be re-esterified into the desired triglyceride form by conventional acid catalyzed esterification with glycerine. The esterification of free fatty acids (usually the polyunsaturated types and more specifically the isomerized linseed oil fatty acids with polyhydroxy compounds such as glycerin) is well known and practiced in the manufacture of improved “drying oil” vehicles for the oil based paint industry (See e.g., M. W. Formo, Industrial Fatty Acids, E. S. Pattison, Ed. Chapter 6, Reinhold N.Y. 1959). The aforementioned process can be identically repeated using oil from chia seeds having a particularly preferred high level of omega-3 in the triglyceride form. Particularly preferred CDA components are in the synergistic combination of monoglycerides, diglycerides, and triglycerides form with the bioactive isomers. More specifically preferred CDA components are in the 2-monoglyceride form with the bioactive isomers.

The compositions of the present invention are preferably formulated by combining dehydrated lesquerolic oil (DLO) into human food supplements and animal feeds. The term DLO is meant in the context of this invention to include: a dehydrated lesquerolic oil derivative component consisting essentially of bioactive isomers of conjugated diene acid in the triglyceride form; a dehydrated lesquerolic oil derivative component consisting essentially of bioactive isomers of conjugated diene acid in the triglyceride form further enriched with a specific bioactive isomer of conjugated diene acid; and a dehydrated lesquerolic oil derivative component consisting essentially of bioactive isomers of conjugated diene acid in the triglyceride form further refined to remove specific non-bioactive components present in dehydrated lesquerolic oil.

DLO has a desirable unsaturated fatty acid profile that can be added in small amounts to the normal diet to yield numerous significant benefits attributed to its superior delivery method of conjugated diene acid (CDA) in the triglyceride (TG) form. DLO is the dehydration product of lesquerolic oil. Note that the CDA of DLO is already in the TG form.

According to the method of the present invention, castor oil, consisting predominantly of lesquerolic acid triglyceride (55%) is subjected to dehydration conditions. Dehydration converts or transforms the lesquerolic acid grouping contained in the oil into conjugated diene acid triglyceride (CDA-TG) along with a relatively high proportion of non-conjugated DLO. Typically the ratio of conjugated to non-conjugated is in the range of 1.1:1 to 1.6:1.

Chemically, the dehydration of lesquerolic oil (acid catalyzed) involves removal of the hydroxyl group and hydrogen from an adjacent carbon atom in the lesquerolic portion of the triglyceride.

The present invention does not preclude the reduction or elimination of specific components of DLO such as non-dehydrated lesquerolic oil using alcohol separation techniques or other known separation techniques. The present invention does not preclude the addition of further supplements including known bioactive isomers of CDA to alter the desired ratio between the isomers themselves. Furthermore, the present invention does not preclude the known techniques to increase the conjugated content in the DLO in order to reduce the total volume requirements to meet the desired total conjugated content. The isomer composition of the various CDA preparations may preferably be confirmed by gas chromatography, as is known in the art.

The present invention as disclosed above is particularly preferred resulting from the dehydration products of chia seed oil. Chia seed is preferably comprised of a significant level of omega-3 triglyceride. All references to lesquerella are equivalently replaced by chia, and all references to dehydrated lesquerella oil are equivalently replaced by dehydrated chia oil.

Recently, preparative liquid chromatography (LC) has received considerable attention for component separation, particularly when it has been applied to valuable pharmaceutical compounds. Although widely used for analytical purposes, elution chromatography in practical application is a batch process, and it is considered to be rather expensive for the large-scale preparation of organic compounds. The use of simulated moving bed chromatography to purify pharmaceutical was rediscovered in the early 1990s. The applications of simulated moving bed chromatography have expanded greatly with the advent of several commercial systems and it is now an established preparative technique for production-scale applications.

Conjugated diene acids in the form of free fatty acids are alternatively converted into an alternative preferred salt form by industry wide practice of creating either an alkali and alkaline salts. The preferred feedstock is seed oil again derived from dehydrated castor, chia, or lesquerella seeds. In the case of preparing salts, the above referred to subsequent step of alkali saponification is replaced with the subsequent step of preparing salts of free fatty acids process performed by use of methods known in the art.

The CDA of above achieve superior nutritional value when further compounded with at least one additional component selected from the group of food enhancing enzyme, microalgae, and immunopotentiator. Food enhancing enzymes when utilized within an animal feed achieves a superior feed conversion ratio. The CDA of CLA, specifically CLA in a free fatty acid, often reduces the growth rate and increases the amount of feed ingested, without such food enhancing enzymes. One such food-enhancing enzyme is galactanase.

Even more preferred is the galactanase of bacterial origin. More particularly preferred is galactanase is derived from a strain of Bacillus. For example, the indigestible galactan is degraded by galactanase, e.g. in combination with .beta.-galactosidase, to galactose or galactooligomers which are digestible by the animal and thus contribute to the available energy of the feed. Also, by degrading galactan, the galactanase may improve the digestibility and uptake of non-galactan feed constituents such as protein, fat and minerals.

Alternative food enhancing enzymes are selected from at least one of the group of proteases, cellulases (endoglucanases), .beta.-glucanases, hemicellulases, lipases, peroxidases, laccases, .alpha.-amylases, glucoamylases, cutinases, pectinases, reductases, oxidases, phenoloxidases, ligninases, pullulanases, arabinases, mannanases, xyloglucanases, xylanases, pectin acetyl esterases, polygalacturonases, rhamnogalacturonases, pectin lyases, pectate lyases, pectin methylesterases, cellobiohydrolases, transglutaminases, and phytases; or mixtures thereof. Further alternative enzymes are selected from the group of proteases, carbohydrases, lipases, reductases, oxidases, transglutaminases, and phytases, or mixtures thereof.

The CDA of above achieve superior nutritional value when further compounded with at least one additional component selected from the group of natural antioxidants. A preferred source of natural antioxidants is from microalgae. A more particularly preferred source is Hawaiian Spirulina, a commercially grown microalgae, having over double the carotenoid profile found in other Spirulina products. Said microalgae demonstrate numerous food enhancing value, including but not limited to better growth rates, higher nutrient uptake, and increased fat transporting enzymes. This results in improved utilization of fat for growth. One proposed feed regiment whereby high omega-3 levels are desired is the utilization of microalgae during the first 85% of the animals life time. During this period, the animal is fed a diet to maximize the conversion of fat into growth. An animal feed ration of up to 5% microalgae is compounded with the standard animal feed mixture. A more preferred animal feed ration of up to 2.5% microalgae is compounded with the standard animal feed mixture. During the latter 15% of the animals life time, the utilization of microalgae is reduced or eliminated concurrently with the increase of oils rich in omega-3 content. The often higher costs associated with omega-3 rich oils, in contrast to standard low cost oils derived from waste stream (e.g., frying oils), non-omega-3 oils (e.g., soybean oil, corn oil, etc.).

The importance of antioxidants in a balanced nutritional diet is gaining increased recognition. It is imperative however, to utilize a diverse source of antioxidants as a means of increasing antioxidant levels. Some antioxidants actually become pro-oxidants which lead to free radical production, specifically the opposite of the desired affect. Antioxidants have a particularly preferred benefit of potentiating the immune system of an animal and a human being. The result is an animal feed, human food, and dietary supplement that protects from infection through its immunopotentiating activity. A particularly preferred immunopotentiator is comprised of Rosa roxburghii, Artemisiae argyi folium and Brassica oleracea var. capitata L.

Rosa roxburghii is a perennial shrub of the family Rosaceae and is native to Guizhou in China and its fruit has been used as the material of juice, jam or liquor. Artemisiae argyi folium is a plant of the family Compositae and has been known to exhibit a low antimicrobial activity only against Gram-positive bacteria. Artemisiae argyi folium includes, for example, Artemisia princeps Pampanini, Artemisia mongolia Fischer, Artemisia argyi LEVL. et VANT., and Artemisia lavandulaefolia DC. Brassica oleracea var. capitata L. is a plant of the family Cruciferae and has been used as food.

A human and animal nutrition composition comprised of BA-CA and L-carnitine in combination with a dietary component or carrier has a number of advantages, including increased feed efficiency, while minimizing individual component levels and providing increased cost effectiveness.

The compositions of the present invention are also preferably formulated by CDA and L-carnitine in order to achieve unexpected synergistic gains.

The composition as an animal feed is preferably comprised of a CDA and L-carnitine component. The CDA component may be in any of the glyceride forms (e.g., triglyceride form, monoglyceride form, diglyceride form, or mixtures thereof) or salt form. The L-carnitine component may be in the form of L-carnitine as a free base, L-carnitine-L-tartrate, L-carnitine magnesium citrate, Acetyl-L-carnitine and L-carnitine in an inert food grade carrier.

The preferred L-carnitine component is influenced by a number of factors, including cost effectiveness, fat content in diet, dispersion and settling characteristics, and emulsion characteristics. Preferred L-carnitine components have L-carnitine in the form of L-carnitine magnesium citrate. The preferred ratio is from 500:1 to 50:1 for CDA components to L-carnitine components. The more preferred ratio is 200:1 for CDA components to L-carnitine components. The blend of CDA and L-carnitine is hereinafter known as “CDA-L-carnitine Blend”. The preferred ratio of CDA-L-carnitine Blend to food composition as utilized in an animal feed diet is influenced by a number of factors, including cost effectiveness, fat content in diet, performance feed efficiency gains, and other probiotic effects. The preferred ratio is from 2:100 for CDA-L-carnitine Blend to food components. The more preferred ratio is 1:200 for CDA-L-carnitine Blend to food components. The preferred ratio of CDA-L-carnitine Blend to total daily food consumption as utilized in an dietary supplement is influenced by a number of factors, including cost effectiveness, fat content in diet, performance feed efficiency gains, and other probiotic effects. The preferred ratio is from 2:100 for CDA-L-carnitine Blend to total daily food consumption. The more preferred ratio is 1:200 for CDA-L-carnitine Blend to total daily food consumption.

The uses of CDA and L-carnitine individually have been well documented in the patent and scientific literature. These uses may be divided into two general categories. The first category is their use nutritionally as a dietary supplement. The second category is their therapeutic and pharmacological uses. The presence of multiple CDA isomers and L-carnitine is superior to any individual isomer of CDA, group of isomers of CDA, or L-carnitine. In the present invention, the ratio of CDA isomers to L-carnitine is less critical than the presence itself of both CDA isomers and L-carnitine when added to human food supplements and animal feeds to provide desirable nutritional, therapeutic and pharmacological effects.

The CDA-L-carnitine Blend is particularly useful in combination with animal feeds as a fat reducing mechanism that involves rejuvenating cell membranes in the muscles and connective tissues to allow fats to freely enter to produce energy and growth. The CDA-L-carnitine Blend is also particularly useful in combination with human feeds as a fat reducing mechanism that involves rejuvenating cell membranes in the muscles and connective tissues to allow fats to freely enter to produce energy and growth.

CDAs largely recognized for their antioxidant qualities, are also referred to as the oil acting similar to omega-3 oils. The higher cost of CDA relative to non-conjugated oils provides the opportunity to further enhance the nutritional value of CDAs by adding at least one oil from the group of oils including rice bran oil, and oils containing omega-3 and omega-9 polyunsaturated fatty acids, and eicosapentacnoic acid, docosahexaenoic acid or mixtures thereof. Rice bran oil is a unique oil rich in natural antioxidants, though not being rich in omega-3 levels. Rice bran oil offers a competitive value in comparison to chia and lesquerella oil, while also providing the unique benefits of oleic acid. A more preferred source of omega-3 is chia seed. Chia seed, being a vegetable source, has none of the high levels of heavy metal (e.g., mercury) associated with fish sources of eicosapentaenoic acid, and docosahexaenoic acid. This is an especially important requirement for human foods of expecting mothers, as omega-3 is critically important to the developing fetus.

Omega-3 rich oils are especially susceptible to oxidation, though chia and lesquerella are significantly less so. Another such means to protect oils from oxidation is through the encapsulation process by methods known in the art. Oxygen is eight times more soluble in fats than in water and it is the oxidation resulting from this exposure that is the primary cause of rancidity. The more polyunsaturated a fat is and especially when that polyunsaturation is conjugated, the faster it will go rancid. This may not, at first, be readily apparent because vegetable oils have to become several times more rancid than animal fats before our noses can detect it. An extreme example of rancidity is the linseed oil (flaxseed) that we use as a wood finish and a base for oil paints. In just a matter of hours the oil oxidizes into a solid polymer. This is very desirable for wood and paint, very undesirable for food.

The more specifically preferred encapsulation is further comprised of active release agents to achieve controlled release of bioactive composition, flavor, pharmaceutical, or nutraceutical actives; bioadhesive agents to bind encapsulant shell and encapsulated actives to mucin and mucosa; and time release agents to regulate the dissolution, melting, or diffusion of the shell. The encapsulated shell is designed to achieve release of the encapsulated bioactive composition by at least one mechanism selected from the group of mechanical rupture of the capsule shell, dissolution of the shell, melting of the shell, and diffusion of the shell.

All feeds and foods require acceptance by the animal or humans respectively beyond the nutritional value. Mouthfeel, texture, and melt temperature requirements vary in accordance to the desired qualities of the finished feed or food product. One such means of modifying the aforementioned physical qualities is through the enzymatic esterification. A significant benefit of enzymatic esterification is the absence of trans fatty acids free of trans fatty acids and with special physical and chemical characteristics. Enzymatic interesterification process can create a random distribution, or it may be directed to a degree that actually modifies the shortening properties, without increasing saturation or creating trans isomers. More preferred oils and fats in the triglyceride form having a minimum of 10% on a weight basis of one or more of omega-3 and omega-9 polyunsaturated fatty acids, eicosapentaenoic acid “EPA” and docosahexaenoic acid “DHA”. More specifically preferred oils are from the group of flax, canola, rice bran, chia, lesquerella, borage, and hemp seeds. Particularly preferred oils are selected from the group of chia, lesquerella, and rice bran whereby these sources are rich in natural antioxidants as a further means of reducing susceptibility to oxidation.

Chia and lesquerella seeds produce oil rich in natural antioxidants as previously mentioned. Both of these seeds are also rich in fiber. Chia seeds in particular contain 55-60% fiber after having the oil extracted from the seed. The high percentage of fiber limits the nutritional value, digestibility, and solubility of animal feeds and human foods containing such seeds, and resulting byproducts from oil extracted meals. This contributes a negative impact on energy value with particular importance for animal feeds. An effective increase in animal feed consumption is required to obtain equivalent growth rates to animal feeds comprised of lower levels of fibers. This also contributes a reduced utilization of the nutritional oils from said chia and lesquerella seeds.

Compounding chia and lesquerella seeds with at least one food enhancing enzyme increases the solubility, digestibility, and utilization of contained nutrients. The food enhancing enzyme can be compounded with seed meal, flour, concentrated protein, isolated protein as a further means of increasing the solubility, digestibility, and utilization of contained nutrients. Such enzymes are selected from the group of enzymes consisting of galactanases, xylanases, proteases, carbohydrases, lipases, reductases, oxidases, transglutaminases, and phytases; and mixtures thereof. A more specifically preferred enzyme is selected from the group of enzymes consisting of galactanases.

Further compounding the chia and lesquerella seeds, and their derivative products with microalgae increases the animal feed feed conversion ratio through the synergistic benefits. The aforementioned Hawaiian Spirulina is one such preferred microalgae. Compounding the animal feed again with up to 5% of Hawaiian Spirulina is particularly preferred. More specifically preferred is a compounding level of up to 2.5%.

Further compounding the chia and lesquerella seeds, and their derivative products with immunopotentiator is another means of increasing the animal feed feed conversion ratio through the synergistic benefits. A particularly preferred immunopotentiator is comprised of the aforementioned Rosa roxburghii, Artemisiae argyi folium and Brassica oleracea var. capitata L.

The oil derived from chia and lesquerella seeds, in addition to oil from rice bran are modified through a process selected from the group of emulsifying into a microemulsion, encapsulating into a microencapsulation, and esterifying through enzymatic interesterification. The addition of the above enzymes, microalgae, and immunopotentiators is preferably done following the microemulsion, and interesterification steps. A more particularly preferred composition is compounding the chia and/or lesquerella oils, or mixtures thereof again prior to the microemulsion and interesterification steps with oils derived from rice bran, dehydrated castor, dehydrated chia, dehydrated lesquerolic, and conjugated linoleic acids as a means to enrich omega-3 and antioxidant levels. Compounding is further comprised of oils containing at least one of omega-3, omega-6, and omega-9 polyunsaturated fatty acids, and eicosapentaenoic acid and docosahexaenoic acid. A more preferred oil contains a minimum of 10% on a weight basis of one or more of omega-3, and omega-9 polyunsaturated fatty acids, and eicosapentaenoic acid and docosahexaenoic acid.

Inclusion of the inventive CDA, and bioactive composition of chia and lesquerella are incorporated into animal feeds, human foods, animal products resulting from consumption of said animal feeds, or dietary supplements. Particularly preferred levels of CDA and bioactive composition are on an isocaloric level as otherwise equivalent animal feeds. Particularly preferred levels of CDA and bioactive composition are on a 1:1 level as otherwise equivalent oils in human foods. More specifically preferred levels of CDA and bioactive composition are determined by a cost to benefit analysis for animal feeds. More specifically preferred levels of CDA and bioactive composition are determined by a cost to price analysis for human foods.

The inventive animal feeds are comprised of said inventive CDA and bioactive compositions and dry or wet mixtures of nutrients, proteins, carbohydrates, and fats. The inventive human foods are comprised of said inventive CDA and bioactive compositions and dry or wet mixtures of nutrients, proteins, carbohydrates, and fats. The inventive CDA and bioactive compositions are manufactured into capsules, liquid drops, or dry powders by methods known in the art.

As previously mentioned, chia and lesquerella seeds contain high levels of fiber comprised of both soluble and insoluble fibers. The high levels of said fibers make the particularly valuable oil, and protein components more difficult to isolate. Oils rich in omega-3 are of particular value as derived from chia seeds. The pretreatment of chia and lesquerella seed components (having a significant level of fibers especially insoluble fibers that contain high amounts of arabinogalactans or galactans) by the addition of galactanase enzymes improves the extraction of oil from oil-rich plant material. Of particular interest is the separation of the chia and lesquerella seeds that are protein-rich or oil-rich crops into valuable protein and oil from the fiber fractions (both soluble and insoluble). The separation process may be performed by use of methods known in the art.

The inventive bioactive composition yields an increase of nutritional value of said animal feed, human food, and animal products resulting from consumption of said animal feeds. The nutritional benefits include, but are not limited to, increased omega-3, antioxidant, solubility and digestion of soluble and insoluble fibers, availability of protein and oils, and reduced levels of oxidized oils. An improvement in organoleptic properties of said animal feed, human food, and animal products also result from the consumption of said animal feeds by enhancing the mouthfeel, texture, viscosity, and melt temperature as required by the specific and respective animal feed and human food. The high natural levels of antioxidant plus the aforementioned means of reducing susceptibility to oxidation further lengthens the shelf-life stability of said animal feed, human food, animal products resulting from consumption of said animal feeds, and dietary supplements due in part. Thus a superior taste of said animal feed, human food, animal products resulting from consumption of said animal feeds, and dietary supplements due in part, though not limited to, reduced oxidation levels avoids the fishy taste typically resulting from the oxidation of oils, particularly oils rich in omega-3 content. The susceptibility of many oils requires expensive means of stabilizing said oils including freezing, refrigerating, vacuum packed, and the use of expensive antioxidants that often modify the taste of said feeds and foods adversely.

A surprising feature of the inventive composition is its effectiveness within diet and nutrition processes. There thus remains a need in the art for an enhanced CDA and/or omega-3 composition that's suitable for a wide range of nutritional, therapeutic, and pharmacological delivery systems, over a wide range of operating conditions, that is non-toxic and compatible with present delivery systems. These and other needs are answered by the present invention.

Without intending to limit the scope of the invention, the following examples describe a method of forming and using the bioactive free fatty acids of conjugated acid of the present invention. Additional features and advantages of the present invention are described in and will be apparent from the detailed description of the presently preferred embodiments. It should be understood that various changes and modifications to the presently preferred embodiments described herein will be apparent to those skilled in the art. Such changes and modifications can be made without departing from the spirit and scope of the present invention and without diminishing its attendant advantages. It is therefore intended that such changes and modifications be covered by the appended claims. All of the examples below are hereinafter referred to as group and known as bioactive free fatty acids of conjugated acid.

### EXAMPLES

### Example 1

Lesquerolic oil is dehydrated thereby yielding conjugated acid triglyceride.

### Example 2

Lesquerolic oil is dehydrated then further catalyzed thereby yielding an increased weight percentage of conjugated acid triglyceride.

### Example 3

DLO-FFA is esterified to increase the weight percentage of conjugated diene acid in triglyceride form when compared to non-esterified dehydrated lesquerolic oil triglyceride.

### Example 4

DLO is compounded with conjugated acid triglyceride to increase weight percentage of conjugated acid in triglyceride form as compared to traditional DLO-TG

### Example 5

DLO is compounded with active isomers of conjugated acid triglyceride to increase the weight percentage of conjugated acid in triglyceride form as compared to traditional DLO-TG

### Example 6

Active isomers of conjugated acid triglyceride are separated from dehydrated lesquerolic oil and compounded to increase the weight percentage of conjugated acid in triglyceride form as compared to traditional DLO-TG

### Example 7

Bulk CLA-L-carnitine Blend is prepared with a 200:1 ratio of conjugated acid triglyceride having bioactive isomers to L-carnitine as a free base.

### Example 8

An animal feed supplement is prepared having a 20,000:100:1 ratio of corn meal to conjugated acid triglyceride with bioactive isomers to L-carnitine as a free base.

### Example 9

A bulk water emulsion is prepared having a 300:100:1 ratio of water to conjugated acid triglyceride with bioactive isomers to L-carnitine as a free base.

### Example 10

Alkali saponified dehydrated castor oil having conjugated linoleic acid free fatty acid converted into a salt with alkali and alkaline metals, hereinafter referred to as “DCO salts” to neutralize the high acid value of conjugated linoleic acid in free fatty acid form.

### Example 11

A DCO salt is encapsulated to mask the high acid value of conjugated linoleic acid in free fatty acid form.

### Example 12

Alkali saponified dehydrated castor oil having conjugated linoleic acid free fatty acid is encapsulated, hereinafter referred to as “DCO microcapsules” to mask the high acid value of conjugated linoleic acid in free fatty acid form.

### Example 13

Alkali saponified dehydrated castor oil having conjugated linoleic acid free fatty acid is compounded with a 200:1 ratio of conjugated acid having bioactive isomers to L-carnitine as a free base and then further encapsulated, hereinafter referred to as “DCO enhanced capsules” to mask the high acid value of conjugated linoleic acid in free fatty acid form.

### Example 14

A dietary supplement tablet is prepared from DCO salts formed into a tablet with an inert carrier.

### Example 15

A nutritional drink is formed by admixing 12 ounces of a fruit juice protein blend with 1.6 grams of DCO microcapsules.

### Example 16

A bulk isolated conjugated acid triglyceride with bioactive isomers is prepared from dehydrated lesquerolic oil and supplemented with DLO to increase weight percentage of conjugated acid as compared to traditional DLO.

### Example 17

An animal feed supplement is compounded from a 100:1 ratio of corn meal to DCO salts.

### Example 18

A dietary supplement tablet is prepared from DLO microcapsules formed into a tablet with an inert carrier.

### Example 19

An animal feed supplement is compounded from a 100:1 ratio of corn meal to DLO.

### Example 20

An animal feed supplement is compounded from a 100:1 ratio of corn meal to DLO microcapsules.

The preceding examples can be equally substituted by other components in the inventive composition. Every instance of DLO can be equivalently replaced with dehydrated chia oil. Each example can be further compounded with food enhancing enzymes, microalgae, and immunopotentiators. Each animal feed mixture can further substitute the standard source of fat with oil derived from chia and lesquerella seeds in an isocaloric level. Each human food can further substitute the standard source of fat with oil derived from chia and lesquerella seeds on a one to one basis with the appropriate level as known in the art of food enhancing enzyme, microalgae, and immunopotentiator as determined by both technical, nutritional, and economic methods known in the art. While the foregoing examples are illustrative of various embodiments of the invention, those of ordinary skill in the art will understand and appreciate that such examples are non-limiting and that variations in for example, bioactive agent, weight percentages, relative percentages, carriers, isomerization or dehydration reaction conditions are contemplated and included within the scope of the present invention which is limited only by the claims appended hereto.

What is claimed is:

1. A bioactive composition comprising a conjugated diene acid selected from at least one from the group consisting of:
glycerides comprising monoglyceride, diglyceride and triglyceride isomers and esters; or
alkali and alkaline salts of conjugated diene free fatty acids.

2. The conjugated diene acid according to claim 1 is further comprised of and at least one additional bioactive component selected from the group of:
food enhancing enzyme;
microalgae; and
immunopotentiator.

3. The conjugated diene acid glycerides according to claim 1 are dehydration compounds of dehydrating at least one oil from the group comprised of castor, lesquerella, and chia seed oil.

4. The alkali and alkaline salts of conjugated diene free fatty acids according to claim 1 are further subjected to encapsulation.

5. The alkali and alkaline salts of conjugated diene free fatty acids according to claim 1 are further subjected to separating bioactive conjugated diene acid from the alkaline saponification compounds.

6. The bioactive composition according to claim 1 is further comprised of L-carnitine.

7. The L-carnitine of claim 6 is selected from the group consisting of free L-carnitine, L-carnitine L-tartrate, L-carnitine magnesium citrate and acetyl-L-carnitine.

8. The bioactive composition according to claim 1 is further comprised of at least one oil from the group of oils including rice bran oil, and oils containing omega-3 and omega-9 polyunsaturated fatty acids, and eicosapentaenoic acid and docosahexaenoic acid.

9. The bioactive composition according to claim 1 is subjected to at least one process selected from the group of emulsifying into a microemulsion, encapsulating into a microencapsulation, and esterifying through enzymatic interesterification.

10. The bioactive composition according to claim 8 is subjected to at least one process selected from the group of emulsifying into a microemulsion, encapsulating into a microencapsulation, and esterifying through enzymatic interesterification.

11. A bioactive composition comprising at least one from the group of chia seed, chia oil, chia protein, lesquerella seed, lesquerella oil, lesquerella protein, and at least one additional bioactive component selected from the group of:
food enhancing enzyme;
microalgae; and
immunopotentiator.

12. The food enhancing enzyme according to claim 11 is further comprised of one or more enzymes selected from the group consisting of galactanases, xylanases, proteases, carbohydrases, lipases, reductases, oxidases, transglutaminases, and phytases; and mixtures thereof.

13. A bioactive composition comprising of at least one enzyme interesterified oil selected from the group of chia, lesquerella, rice bran, dehydrated castor, dehydrated chia, dehydrated lesquerolic, and conjugated linoleic oils as a means to enrich omega-3 and antioxidant levels.

14. The bioactive composition of claim 13 further comprised of oil containing at least one of omega-3, omega-6, and omega-9 polyunsaturated fatty acids, and eicosapentaenoic acid and docosahexaenoic acid.

15. The oil of claim 14 is selected from at least one from the group of oils and fats in the triglyceride form with a minimum of 10% on a weight basis of one or more of omega-3, and omega-9 polyunsaturated fatty acids, and eicosapentaenoic acid and docosahexaenoic acid.

16. The interesterified oil according to claim 13 is further subjected to one process selected from the group of emulsifying into a microemulsion or encapsulating into a microencapsulation

17. The bioactive composition according to claims 1, 6, 8, 9, 10, 11, 12, 13, 14, and 16 is further compounded into an animal feed, human food, animal products resulting from consumption of said animal feeds, or dietary supplements whereby:
animal feed includes dry or wet mixtures of nutrients, proteins, carbohydrates, and fats;
human food includes dry or wet mixtures of nutrients, proteins, carbohydrates, and fats;
resulting animal products include meat products derived from the consumption of said animal feeds; and
dietary supplements include capsules, liquid drops, and dry powders of said bioactive compositions.

18. The bioactive composition according to claims 1, 6, 8, 9, 10, 11, 12, 13, 14, and 16 improve at least one of the group of benefits selected from:
nutritional value of said foods; and
organoleptic properties of said foods.

19. The bioactive composition according to claims 1, 6, 8, 9, 10, 11, 12, 13, 14, and 16 at least one of the group of benefits selected from:
shelf-life stability of said products; and
taste in said products.

20. The bioactive composition according to claim 11 improve the isolation of oil, protein, carbohydrate, and fiber from at least one seed preferably selected from the group of chia and lesquerella seeds, and whereby the enzyme according to claim 11 is selected from the group of galactanase enzymes.
